(19) United States
(12) Patent Application Publication
(10) Pub. No.: US 2008/0145184 A1
(43) Pub. Date: Jun. 19, 2008

(54) Fastening Device

(75) Inventors: Goran Levin, Hisings-Karra (SE); Jan-Olof Bodin, Alingsas (SE)

Correspondence Address: WRB-IP LLP, 1217 KING STREET, ALEXANDRIA, VA, 22314, US

(73) Assignee: VOLVO LASTVAGNAR AB, Goteborg (SE)

(21) Appl. No.: 11/813,347

(22) PCT Filed: Feb. 8, 2006
(86) PCT No.: PCT/SE2006/000173

§ 371 Date: Jul. 4, 2007

(30) Foreign Application Priority Data
Mar. 8, 2005 (SE) 0500531-9

(51) Int. Cl. F16B 35/04; F16B 5/02

(52) U.S. Cl. 411/426

(57) ABSTRACT

A fastening device for joining together mechanical parts is provided, where the fastening device includes integrated cutting edges that are so arranged, during assembly of the fastening device, as to remove material from the envelope surfaces of the assembly hole by cutting in a rotating movement, so that the assembly hole is caused to fit the envelope surface of the fitting part. A fastening device can be provided which, by simple and inexpensive means, is so arranged as to absorb both shearing loads and tensile/compressive loads arising between the joined parts.

### BACKGROUND AND SUMMARY

The present invention relates to a fastening device.

Mechanical parts that are subjected to high stresses in different directions are joined traditionally by means of two types of joint, on the one hand shearing load-absorbing joints, e.g. rivets, and on the other hand tensile/compressive load-absorbing joints, e.g. screwed joints. Conventional screwed joints have a limited shearing load-absorbing capacity because of the clearance between the screw and the hole in the joint. This clearance can be eliminated by means of special tools, whereby the hole is precision machined to give a press fit with a special screw, a so-called fitting bolt. This type of joint involves high assembly costs.

A combination of screwed joints and riveted joints is thus normally used in the assembly of a chassis for a goods vehicle, for example, since the joint must also be capable of absorbing shearing loads. Screwed joints are used alone when only tensile loads must be absorbed. The combination of screwed joints and riveted joints takes up an unnecessarily large space and requires a number of different assembly operations. Fitting bolts are time-consuming to install and costly, and they are accordingly used only in cases of extreme need.

It is desirable to provide a fastening device which, in a single type of joint, combines shearing load-absorbing and tensile/compressive load-absorbing capacity without the need for special machining of the assembly hole.

### DESCRIPTION OF THE DRAWINGS

The invention is described below as an example, in conjunction with which reference is made to the accompanying drawings, in which:

FIG. 1 illustrates a side view of a fastening device according to the invention,

FIG. 2 illustrates an end view of the fastening device according to FIG. 1,

FIG. 3 illustrates a fastening device without a rotary part,

FIG. 4 illustrates a fastening device when assembly is about to start, and

FIG. 5 illustrates a fastening device in its final, assembled state.

### DETAILED DESCRIPTION

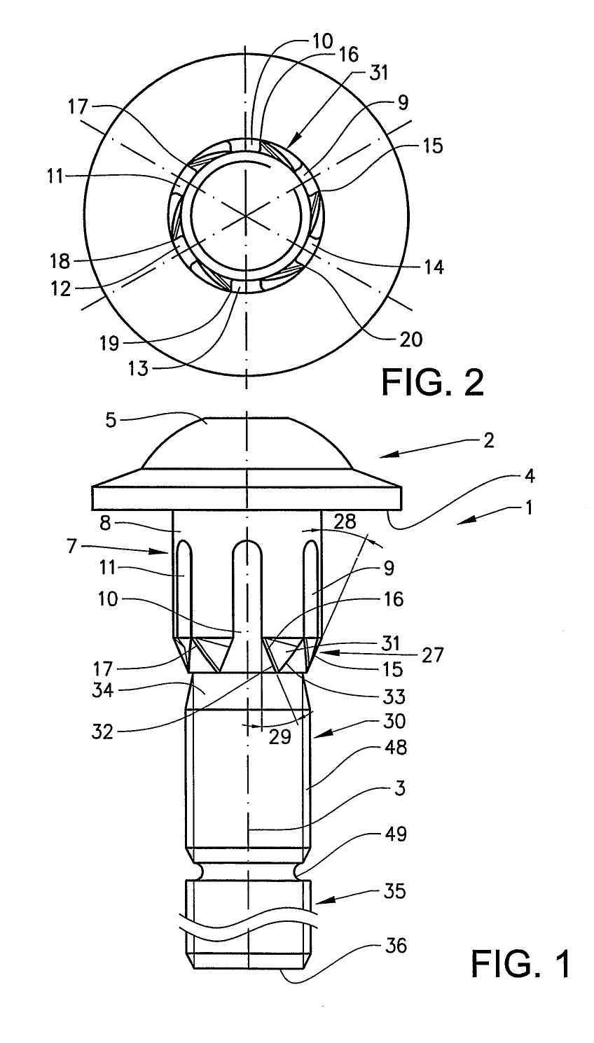

The construction of the fastening device can be appreciated from FIG. 1. The fastening device 1 is executed in the illustrated example as a screw or a bolt and comprises a head 2, a fitting part 7 and a fastening part 30.

The head 2 is arranged to essentially absorb forces in the longitudinal direction of the fastening device in the finished joint, i.e. in the direction of the longitudinal axis 3. For this purpose, the head 2 exhibits a contact surface 4 that is annular and appropriately flat and extends in a radial plane to the longitudinal axis. The head 2 also exhibits an envelope surface 5 that faces away from the contact surface 4 and can be given an optional, appropriate form.

The envelope surface 5 of the head can be embodied in a further development with an internal engaging part 6, e.g. in the form of a hexagonal key socket, for the rotating driving of the fastening device about the longitudinal axis 3. An internal engaging part is advantageous when a low height for the head is desirable. It is also possible to provide the head with an external engaging part, e.g. in the form of a means of engagement for a hexagonal socket for driving the fastening device with a nutrunner, for example. An engaging part can be desirable not only for the assembly of the fastening device, but also as an abutment in the event that the fastening device must be capable of being released.

The fitting part 7 is so arranged as to extend after assembly through, and to fit in the hole in which the fastening device is to sit. For this purpose, the fitting part exhibits an essentially cylindrical envelope surface 8 with a diameter accurately adapted in relation to the size of the hole. According to the invention, the fitting part exhibits grooves 9-14, which are uniformly distributed over the envelope surface and open out at their one end at a conically tapering part 27 of the fitting part and extend along the longitudinal axis 3 of the fastening device. The grooves 9-14 extend over most of the length of the fitting part 7 and are intended to accommodate surplus material, such as machining swarf and paint that is released in conjunction with assembly of the fastening device. The design of the grooves is adapted to the quantity of material that will be removed. The number of grooves can also be varied, although an advantageous number is between 3 and 8. The grooves are formed in an appropriate fashion when the fastening device is manufactured, e.g. by cold upsetting or by rolling.

The grooves can also be filled with some form of wax or similar, which coats the grooves before the fastening device is assembled. On the one hand, this prevents foreign material from becoming lodged in the grooves before use, and it is also used as a lubricant in conjunction with assembly. When the fastening device is assembled, so much frictional heat is generated that the wax melts. This lubrication facilitates the drawing of the envelope surface 8 into the assembly hole, which, after machining, exhibits a press fit with the envelope surface. Wax treatment of the fastening device also helps to protect the cutting edge from corrosion.

The fitting part 7 exhibits a conically tapering part 27, situated beneath the cylindrical envelope surface 8, provided with cutting edges 15-20 for removing material from the assembly hole so that it fits against the envelope surface 8. Each cutting edge 15-20 is formed on a cutting part 21-26 in the conically tapering part 27. Because the cutting parts originate from the envelope surface 8, the largest diameter of a cutting edge will correspond to the diameter of the envelope surface, which provides a press fit between the machined hole and the envelope surface 8. The angle of inclination 28 formed by the conically tapering part 27 in relation to the envelope surface is selected so that an appropriate cutting angle is formed with the hole in which the fastening device will be assembled. A suitable angle of inclination 28 lies in the interval from 10 to 30°, although other angles of inclination are conceivable depending on the dimensions and materials of the component parts that will be joined together. The envelope surface 8 can be ground in order to achieve a high tolerance where this is desirable.

A cutting edge will now be described in more detail. The cutting edge 16 forms a cutting angle 29 with the direction of the longitudinal axis. This angle preferably lies in the interval between 0 and 60°. A cutting part 31 is embodied in such a way that the cutting part is chamfered towards the fastening device. The cutting parts are also formed in an appropriate fashion when the fastening device is manufactured, e.g. by cold upsetting or by rolling. This means that the front part 32 of the cutting part lies on a level with the envelope surface of the fastening device, and the rear part 33 of the cutting part lies on a level with the bottom of the groove 10, so that a clearance is formed behind the cutting edge when the fastening device is assembled, i.e. so that only the cutting edge is in contact with and works the material in which the fastening device is assembled. A cutting edge 16 is present in the front part 32 of the cutting part. The cutting edge is most easily produced by grinding the conical part so that all the cutting edges are formed at the same time. When the cutting edges are ready, it is advantageous to harden the cutting edges so that they exhibit the desired hardness. Hardening can take place in various ways, e.g. by case-hardening or laser hardening. The front edge of the cutting part, between a cutting edge and the fastening device, gathers up the material that is removed by cutting when the fastening device is assembled. The removed material is then passed into the grooves 14-20.

Below the fitting part 7, the fastening device 1 exhibits a fastening part 30 that is intended for fastening in an opposing fastening device, such as a nut, in conjunction with which the fastening part 30 is threaded and has a diameter smaller than the diameter of the fitting part, so that the fastening part can be introduced through the hole in which the fitting part will fit. In the illustrated example, the fastening part 30 also exhibits a chamfered part 34 towards the fitting part 7, so that the conically tapering part 27 is clearly marked.

A rotary part 35 is also arranged on the fastening part 30. An indication of fracture 49 is arranged between the rotary part 35 and the fastening part 30. The rotary part 35 is used in an illustrative embodiment for the assembly of the fastening device.

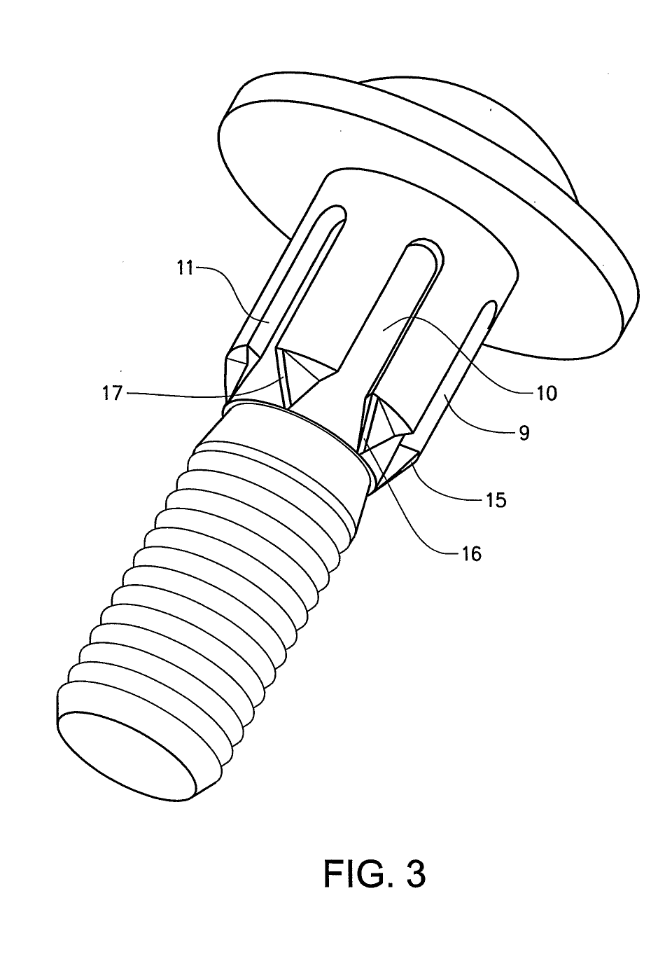

FIG. 2 illustrates an end view of the fastening device, observed from the rotary part 35, in conjunction with which its end surface 36 is represented by the two innermost circular lines. Projecting beyond these are ends of the grooves 9-14, i.e. openings, which are uniformly distributed over the envelope surface. The cutting edges 15-20 and the cutting parts, of which 31 is indicated, can also be seen.

Illustrated in FIG. 3 is a three-dimensional view of a fastening device without a rotary part. In one illustrative embodiment, for example, is the fastening device intended for the assembly of two beam components on a goods vehicle chassis, each of which components is 8 mm thick. Suitable dimensions may then be as follows, for example: the diameter of the envelope surface is 16 mm and is intended for assembly in an assembly hole that is 14-15 mm. The angle of inclination 28 is 20°, and the cutting angle 29 is 30°. The threaded part of the fastening device 48 also has a M14 thread. The length of the envelope surface is 16 mm. The clearance angle of the cutting edge is 7°. These measurements are only intended as examples of a fastening device intended for the above-mentioned assembly.

In order to be able to remove material from the envelope surfaces of the assembly hole by cutting, the fastening device, or at least the cutting edges, must be significantly harder than the material where the fastening device is assembled. It is advantageous, therefore, to manufacture the fastening device in a material that is harder than the materials where the fastening device will be assembled. It is also possible to harden the whole of the fastening device or only the cutting edges in order to enable reliable removal of material by cutting. The dimensioning of the strength of the fastening device also depends on the loads that the assembled fastening device will absorb.

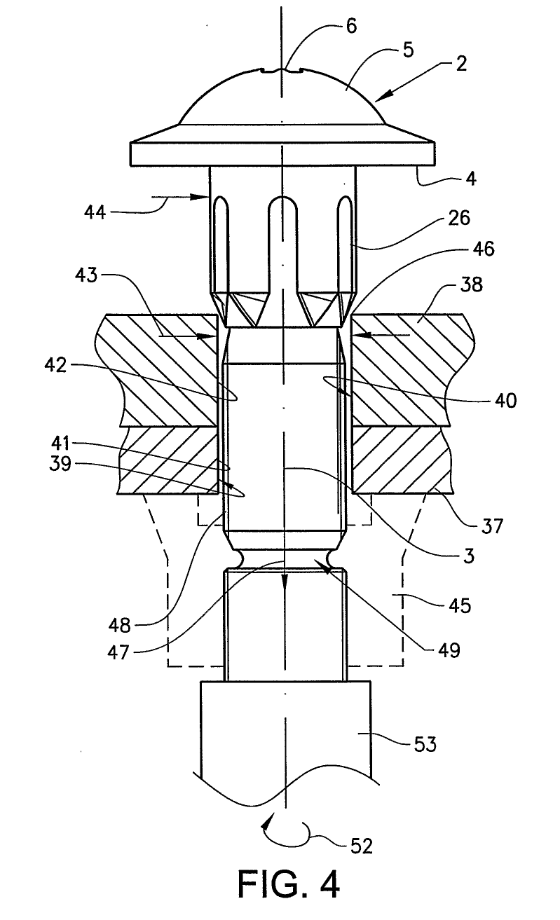

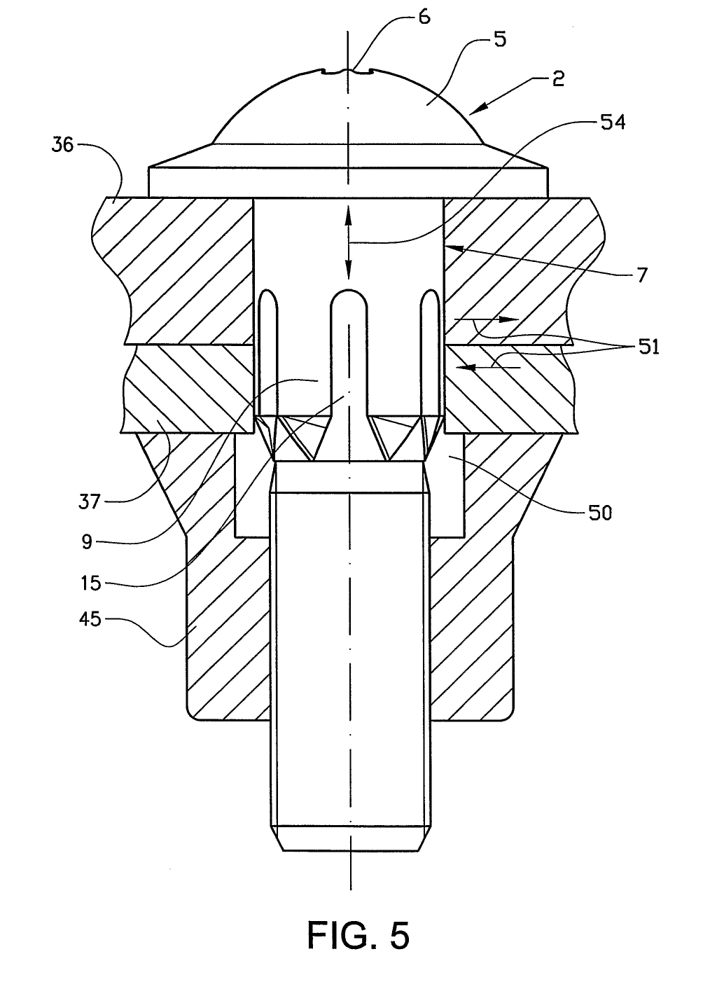

FIGS. 4 and 5 illustrate the function of the fastening device as a cross section through a joint between two mechanical parts 37, 38. The two mechanical parts can be two parts of a beam construction for a motor vehicle that will be connected to one another. Each of the two parts is provided with its own transcurrent hole 39, 40 which are arranged opposite one another, i.e. they are coaxial and exhibit a concave envelope surface 41, 42 in the form of a cylinder jacket that is prefabricated with a diameter 43 that is smaller than the diameter 44 of the fitting part but exceeds the smallest diameter of the conically tapering part 27. The diameter 43 also exceeds the largest diameter of the fastening part 30. It is also possible to join more than two parts with a single fastening device, where this is desirable. In a typical assembly, a plurality of fastening devices is used in order to achieve the attachment of, for example, two beams to a goods vehicle frame.

In the circumstances indicated above, the following takes place in conjunction with assembly of the fastening device in order to create a joint between the two parts 37, 38. The fastening device is first introduced with its fastening part 30 through the coaxially arranged holes 39, 40, which together form the assembly hole, until the fitting part 7 with its conical part 27 makes contact with the peripheral edge 46 of the first hole 40. In this position, the cutting edges 15-20 are in contact with the peripheral edge 46. The fastening device is then driven in the direction of the longitudinal axis, more specifically in the direction of the arrow 47. This driving is performed in a rotating fashion, as shown by the arrow 52, so that the cutting edges 15-20 cut away surplus material on the envelope surfaces 41, 42, which gives the assembly hole the same diameter as the envelope surface 8, in conjunction with which a press fit is obtained between the fastening device and the assembly hole. In this way, the joint can absorb shearing loads at the same time as tensile loads.

The rotating introduction can be performed in two ways. In one illustrative embodiment, the fastening device is caused to rotate by means of the engaging part 6 so that the cutting edges of the fastening device remove material from the envelope surfaces of the assembly hole. This can take place, for example, by a nutrunner or some other rotating tool causing the fastening device to rotate, advantageously at a relatively low speed. At the same time, pressure is applied to the fastening device so that the cutting edges can remove the surplus material in the assembly hole by cutting and, in so doing, can permit the fastening device to advance into the hole. When the fastening device is introduced fully into the assembly hole, i.e. when the contact surface 4 of the head is in contact with the mechanical part 38, a nut 45 is applied in a conventional way. In this method of assembly, the rotary part 35 of the fastening device is superfluous, and a fastening device without a rotating part is used accordingly.

In another illustrative embodiment, an assembly tool 53 is applied to the rotary part 35 of the fastening device. When the fastening device has been introduced into the assembly hole, a clamping sleeve 45 is first passed over the rotating part and the fastening part so that the clamping sleeve makes contact with the mechanical part 37. The assembly tool then locks the rotary part securely so that the assembly tool can cause the fastening device to rotate about the direction of the longitudinal axis, at the same time as a tensile moment is applied so that the fastening device is drawn into the assembly hole during removal of material from the envelope surfaces 41, 42 by cutting.

When the fastening device is fully introduced into the assembly hole, i.e. so that the contact surface 4 of the head is in contact with the mechanical part 38, the fastening device is pre-tensioned at the same time as the clamping sleeve 45 is cold formed against the threaded part 48 of the fastening part, so that a mechanical joint is produced. The clamping sleeve can either be round or, if it must be capable of being released, can be embodied with an outer engaging part, e.g. a hexagonal engagement means. When the clamping sleeve is formed and ready, the assembly tool applies a further tensile force to the rotary part so that the rotary part is released from the fastening part, i.e. so that the rotary part is broken off from the fastening part. In order to achieve a controlled break, the fastening device is provided with an indication of fracture 49, which joins the rotary part to the fastening part. If the joint must not be capable of being released, the threaded part 48 of the fastening part can be replaced by a number of grooves all the way round without an increment, which means that the clamping sleeve cannot be removed by rotating it after clamping. A similar method of assembly is previously disclosed for ordinary screwed joints and is supplied by the Huck Fasteners company, for example.

When the fastening device is assembled in the assembly hole, the fitting part 7 extends through the two mechanical parts 37, 38 and, by so doing, through the holes 39, 40. The envelope surface 8 of the fitting part in this way makes contact with envelope surfaces 41, 42 of the holes. Depending on the requirements that are imposed on the fastening device and the fastening, the envelope surface 8 can make full contact with the envelope surfaces of both holes, or the envelope surface 8 can make only partial contact with the envelope surface of one of the holes, i.e. the envelope surface 8 does not extend all the way through the assembly hole. Advantageously, however, the envelope surfaces of both holes are worked fully by the cutting edges so that the envelope surface 8 makes full contact with the envelope surfaces of both holes.

During the driving-in movement, the removal of material by cutting will be performed by the cutting edges 15-20, which remove material by cutting on the envelope surface 41, 42 of the holes 39, 40. In this way, the cutting edges 15-20 will also serve as cutting tools, at the same time as material swarf can be contained in the grooves 9-14 and/or in the space 50 in the clamping sleeve 45. The size of the space 50 is created by the unthreaded part of the clamping sleeve 45. This space can be used to gather material that has been removed by cutting. The length of the unthreaded part of the clamping sleeve 45 is also adapted so that the pre-tensioning that is to be imparted to the fastening device can be achieved.

Through the removal of material that is performed by cutting, the hole diameter will thus be increased and adapted to the hole diameter 44 of the fitting part over the cylindrical envelope surface 8, and the end result will be a joint, see FIG. 5, without a clearance between the fitting part and the assembly hole, which thus results in a joint with the ability to absorb both shearing forces in the direction of the arrows 51 and axial forces in the direction of the arrow 54.

The invention is not restricted to the illustrative embodiment described above and illustrated in the drawings, but can be varied within the scope of the following patent claims. For example, the extent and inclination of the grooves can vary, as can the cross-sectional form of the grooves, and as can the design of the cutting edges.

### REFERENCE DESIGNATIONS

1: fastening device
2: head
3: direction of longitudinal axis
4: contact surface
5: stop surface of the head
6: engaging part
7: fitting part
8: cylindrical envelope surface
9-14: grooves
15-20: cutting edges
21-26: cutting part
27: conically tapering part 28: angle of inclination
29: cutting angle
30: fastening part
31: cutting part
32: cutting part, front part
33: cutting part, rear part
34: chamfered part
35: rotary part
36: end surface
37, 38: mechanical parts
39, 40: transcurrent holes
41, 42: concave envelope surface in the form of a cylinder jacket
43: hole diameter
44: diameter of the fitting part
45: clamping sleeve, nut
46: peripheral edge
47: assembly direction
48: threaded part of the fastening part
49: indication of fracture
50: space
51: direction of shearing force
52: direction of rotation
53: assembly tool
54: direction of axial force

1. A fastening device for joining together mechanical parts and comprising a fitting part so arranged as to extend through holes which form an assembly hole, a cylindrical envelope surface so arranged as to make contact with envelope surfaces of the assembly hole, a head having a contact surface for contact with a contact surface on one side of the assembly hole, and a fastening part having a diameter that is smaller than the diameter of the assembly hole and is so arranged as to fasten in a fastening component, wherein the fitting part exhibits a diameter that is slightly larger than the diameter of the assembly hole in its condition before fastening of the fastening device and exhibits cutting edges that are so arranged, during assembly of the fastening device, as to remove material from the envelope surfaces of the assembly hole by cutting in a rotating movement, so that the assembly hole is caused to fit the envelope surface of the fitting part, by means of which the fastening device is so arranged as to absorb both shearing loads and tensile/compressive loads arising between the joined parts, and a rotary part intended to be used for causing the fastening device to rotate in conjunction with assembly, and wherein an indication of fracture part connects the rotary part to the fastening part.

2. The fastening device as claimed in claim 1, wherein the fastening device also comprises grooves for accommodating material removed by cutting which arises in conjunction with assembly.

3. The fastening device as claimed in one of claim 1, wherein the head is provided with an internal engagement part.

4. The fastening device as claimed in one of claim 1, wherein the head is provided with an external engagement part.

5. The fastening device as claimed in one of claim 1, wherein the fastening part comprises a threaded part adapted to be assembled with a nut.

6. The fastening device as claimed in one of claim 1, wherein the fastening part comprises a part with grooves.

7. The fastening device as claimed in claim 6, wherein the grooves are filled with a lubricating medium.

8. The fastening device as claimed in claim 7, wherein the lubricating medium is intended to be caused to melt by frictional heat that is generated during assembly.

9. A vehicle comprising a plurality of fastening devices as claimed in one of claim 1.

10. The fastening device as claimed in claim 2, wherein the grooves are filled with a lubricating medium.
